(19) United States
(12) Patent Application Publication
(10) Pub. No.: US 2010/0141855 A1
(43) Pub. Date: Jun. 10, 2010

(54) IMAGE DISPLAY APPARATUS

(76) Inventor: Owen John Williams Wynn, West Sussex (GB)

Correspondence Address: Iandiorio Teska & Coleman, 260 Bear Hill Road, Waltham, MA, 02451, US

(21) Appl. No.: 12/312,833

(22) PCT Filed: Oct. 24, 2007
(86) PCT No.: PCT/GB2007/004056

§ 371 Date: Feb. 5, 2010

(30) Foreign Application Priority Data
Dec. 1, 2006 (GB) 0624092.3

(51) Int. Cl. G02F 1/1335; G02F 1/29

(52) U.S. Cl. 349/5; 359/316

(57) ABSTRACT

Image display apparatus (2) comprising a spatial light modulator (4), at least one light source (6) for producing a light beam which illuminates a portion of the spatial light modulator (4), light beam redirecting means (8) to redirect the light beam such that all portions of the spatial light modulator (4) are able to be illuminated, first control means for controlling the redirection of the light beam as a function of video data (12) input to the image display apparatus (2), second control means (14) for controlling the spatial light modulator (4) as a function of the video data (12) input to the image display apparatus (2), and third control means for controlling the illumination intensity of the light beam as a function of the video data input to the image display apparatus (2).

This Invention relates to image display apparatus and, more especially, this invention relates to image display apparatus having a laser light source.

Image display apparatus for displaying images by projection utilising one or more lasers as the light source or light sources is well known. One type of known laser based projection apparatus comprises a laser light source and beam shaping optics to expand the laser light beam such that a spatial light modulator is fully illuminated by the expanded laser light beam. This light is then modulated by the spatial light modulator in accordance with video data. The resultant image is displayed using projection optics and a projection screen. Laser light sources are monochrome light sources. Therefore, in order to display colour images, three laser light sources, usually red, green and blue laser light sources, are used and combined using optics within the projector, or combined on the projection screen, to form a full colour image. This known projection image display apparatus may utilise many types of spatial light modulator such as digital micro-mirror devices as made by Texas Instruments, transmissive or reflective liquid crystal spatial light modulators or ferroelectric spatial light modulators. Because the known projection image display apparatus uses a laser light source to replace the lamp of a recognised projection system, it suffers the same drawbacks in performance and in particular relatively low contrast.

Other known projection image display apparatus utilises laser light sources in different ways. One way is to use beam shaping optics to shape the laser light beam into a line which is used to illuminate a spatial light modulator which is a linear spatial light modulator, usually being one pixel wide and up to 4000 pixels in length. The line of laser illumination is modulated by the linear spatial light modulator which is in turn scanned in an orthogonal direction to create the final image. This system is used in projectors which incorporate a grating electro mechanical system or a grating light valve. These projectors will also have limitations in certain areas of performance. In particular, the contrast of such a system is relatively low, being approximately 1000:1. In this type of image display apparatus using a grating electro mechanical system or a grating light valve device, the modulated light is scanned to provide the complete image on the screen.

In the above examples of known image display apparatus, the laser light source used is a constant light source and it is used solely to illuminate the spatial light modulator. The spatial light modulator is used to provide all the image information which is displayed.

It is an aim of the present invention to provide image display apparatus for projecting images with a laser light source, which image display apparatus has improved performance.

Accordingly, in one non-limiting embodiment of the present invention there is provided image display apparatus comprising a spatial light modulator, at least one light source for producing a light beam which illuminates a portion of the spatial light modulator, light beam redirecting means to redirect the light beam such that all portions of the spatial light modulator are able to be illuminated, first control means for controlling the redirection of the light beam as a function of video data input to the image display apparatus, second control means for controlling the spatial light modulator as a function of the video data input to the image display apparatus, and third control means for controlling the illumination intensity of the light beam as a function of the video data input to the image display apparatus.

The spatial light modulator may be a reflective spatial light modulator or a transmissive spatial light modulator.

The reflective spatial light modulator may be a liquid crystal reflective spatial light modulator such for example as a liquid crystal on silicon modulator or a ferroelectric spatial light modulator. The reflective spatial light modulator may alternatively be a micro electro-mechanical system such for example as a digital micro-mirror device, a grating light valve, a grating electro mechanical system spatial light modulator or any other suitable and appropriate type of reflective spatial light modulator.

The spatial light modulator may be a transmissive spatial light modulator such for example as a transmissive liquid crystal spatial light modulator, or any other suitable and appropriate type of transmissive spatial light modulator.

The image display apparatus may be one in which the light source is a laser light source. The laser light source may be a monochromatic laser light source. The laser light source may be in the visible spectrum, for example a red laser, green laser or blue laser. The laser light source may be not in the visible spectrum so that it may be for example an infrared laser light source. Alternatively the laser light source may be a white or yellow laser light source.

Alternatively, the image display apparatus may be one in which the light source is a light emitting diode light source comprising one or more light emitting diodes. This light emitting diode light source may be a monochromatic light emitting diode light source. The light emitting diode light source may be in the visible spectrum, for example a red light emitting diode, green light emitting diode or blue light emitting diode. The light emitting diode light source may be not in the visible spectrum such as an infrared light emitting diode light source. Alternatively the light emitting diode light source may be a white or yellow light emitting diode light source. Alternatively, the light source could be an electron beam addressed solid state laser.

The light beam which illuminates a portion of the spatial light modulator may be circular in cross section, rectangular in cross section, or of any other suitable and desired cross sectional shape such for example as an ellipse. This may be achieved by optical means but the light beam of whichever shape will only illuminate a portion of the spatial light modulator.

The light beam redirecting means may be optical light beam redirecting means such for example as a mirror galvanometer, an acousto-optical device, a MEMS device, a polygonal mirror, a piezo-scanner, or an electron scan addressed device.

The light beam redirecting means may be a spatial light beam redirecting means such for example as a spatially arrayed light source. The spatially arrayed light source may be one in which an electron beam is scanned over a solid state faceplate such that the laser light beam emanates from the point where the electron beam strikes the faceplate.

The video data input may be monochrome image data. The monochrome image data may be monochrome image data in the visible part of the spectrum such as red, green or blue image data or, it may be image data in the non-visible part of the spectrum such for example as infrared image data.

The video data input may be a full colour video image data.

The first control means for controlling the redirection of the light beam may extract necessary data such for example as video timing information from the video data input. This may be at the video line rate, video frame rate, sub frame rate, or multiple frame rates.

The second control means for controlling the spatial light modulator may extract necessary data for controlling the spatial light modulator as a function of the video data input.

The third control means for controlling the illumination intensity may extract data from the video data input to control the intensity of the light source. The light source intensity may be controlled as a function of the video data input by being a function of the video information or a function of the video timings, or in conjunction with the light beam redirection means and controlled as a function of the position of the light beam relative to the spatial light modulator.

The image display apparatus may be one in which images are projected by projection optics onto a projection screen. The projection screen may be a front projection screen or a rear projection screen. The display apparatus may be one in which the spatial light modulator is incorporated into a projection screen. This projection screen may also be a front or rear projection screen.

The image display apparatus may be used in conjunction with other like apparatus, each displaying a different monochrome image (for example one displaying a red image, one displaying a green image, and a third displaying a blue image) to provide full colour image display apparatus. The images from each of the red, green and blue image display apparatuses may be combined optically on a screen. Alternatively they may be combined using optical combination means to combine the red, green and blue images before the projection optics such that the colour image is displayed using common projection optics. Other colour light sources may also be combined to give colour images, or images which include images within the infrared part of the spectrum for example.

The first, second and third control means may form separate parts of a single means such for example as a common image processing unit.

As indicated above, the image display apparatus may have one or more of the light sources. When there is more than one of the light sources, each light source may have its own one of the redirection means and the intensity control means. The one or more light sources may be configured using optical means to illuminate a single spatial light modulator which modulates the intensity of combined light beams such that a colour image is able to be displayed using projection optics for example.

Embodiments of the invention will now be described solely by way of example and with reference to the accompanying drawings in which:

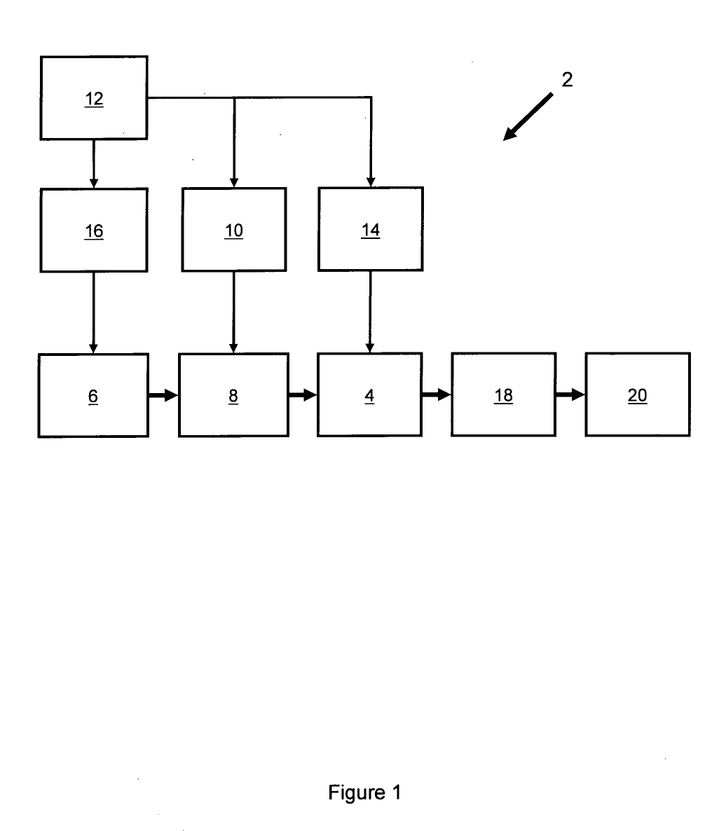

FIG. 1 shows schematically image display apparatus of the present invention;

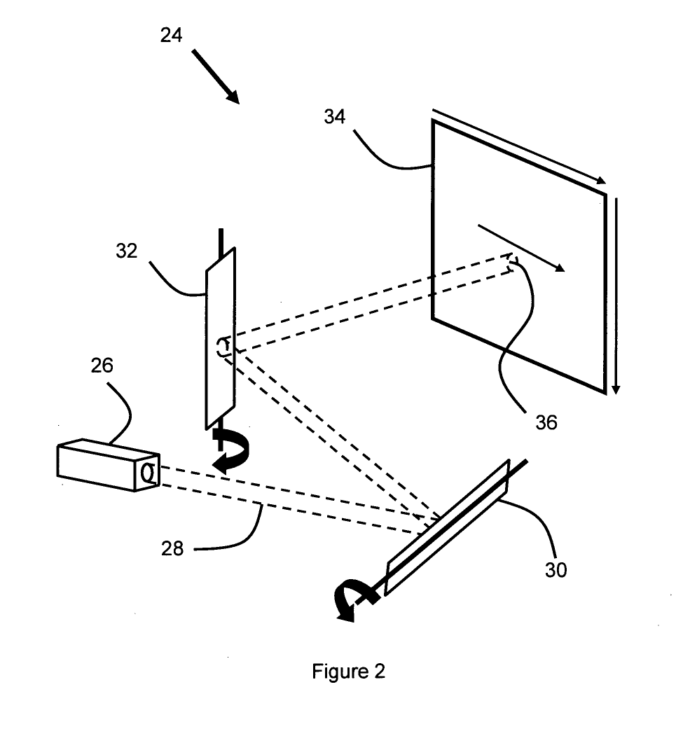

FIG. 2 shows the light source, and light beam redirection means which redirects the light beam;

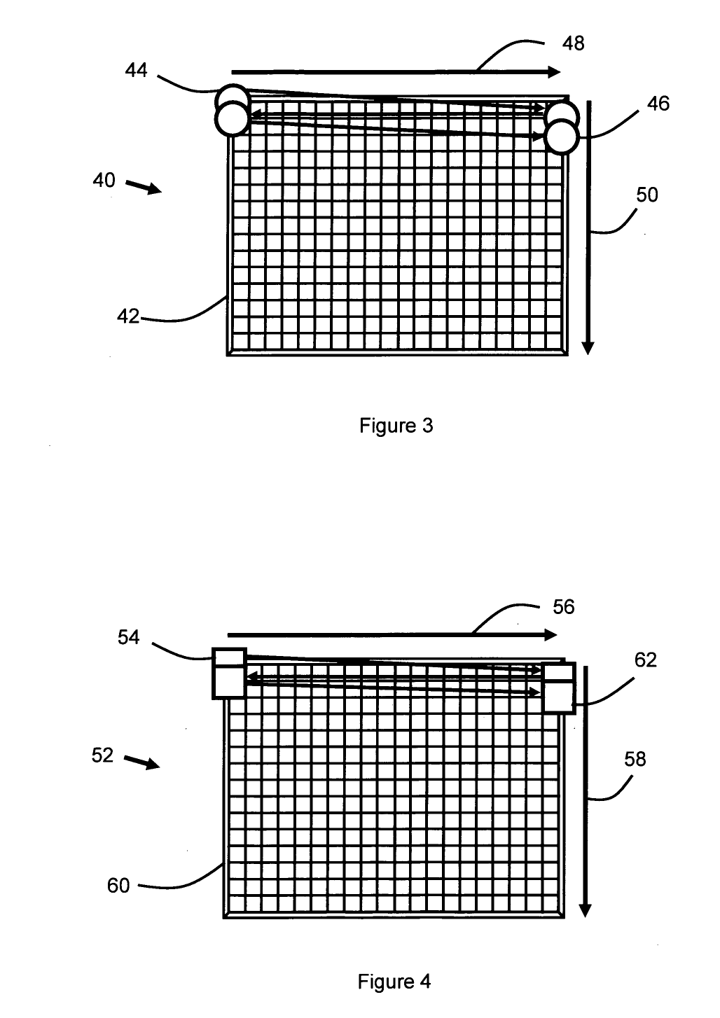

FIG. 3 shows the spatial light modulator and the light beam;

FIG. 4 shows the spatial light modulator and light beam having an alternative cross section;

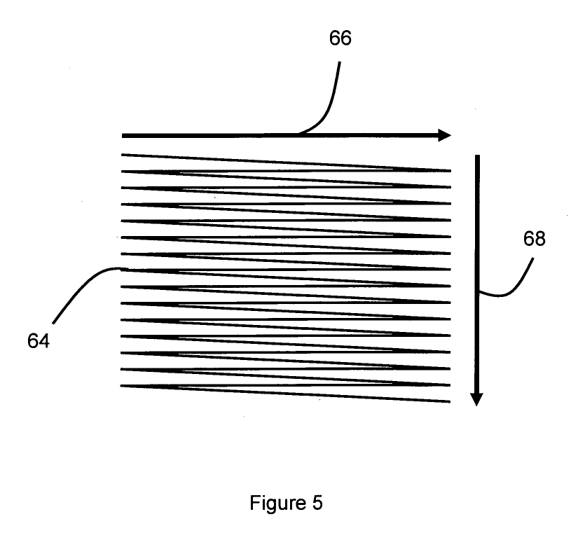

FIG. 5 shows a path which the light beam may take to scan the spatial light modulator in two directions;

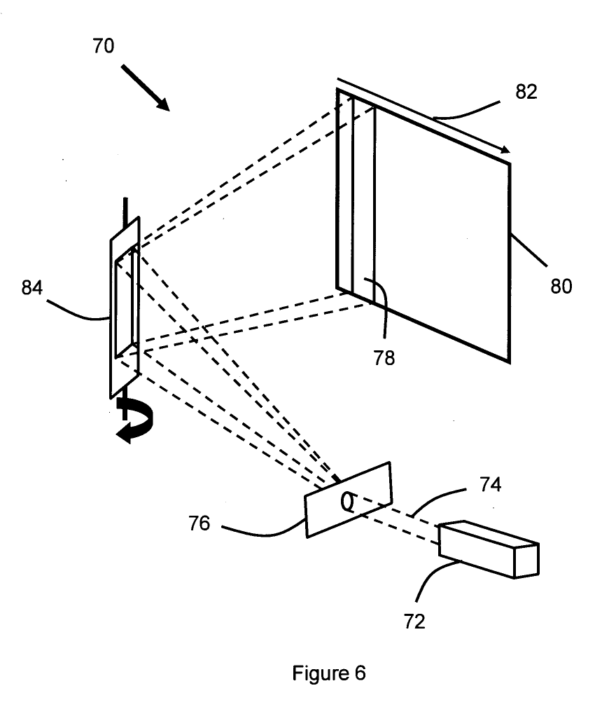

FIG. 6 shows alternative shape light beam and redirection means to redirect the light beam in one direction;

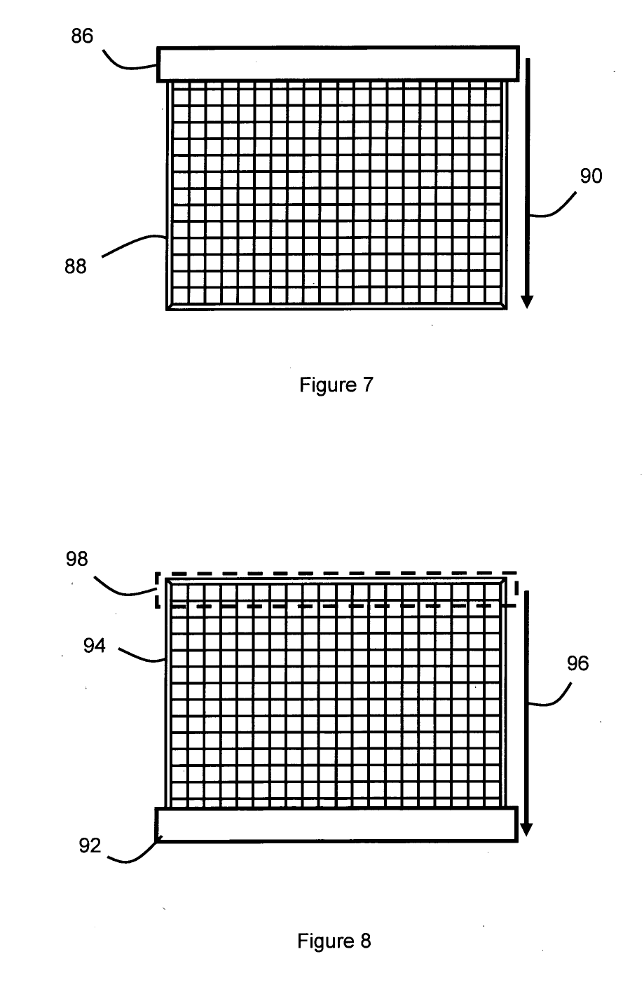

FIG. 7 shows the light beam and a spatial light modulator;

FIG. 8 shows the light beam and a spatial light modulator;

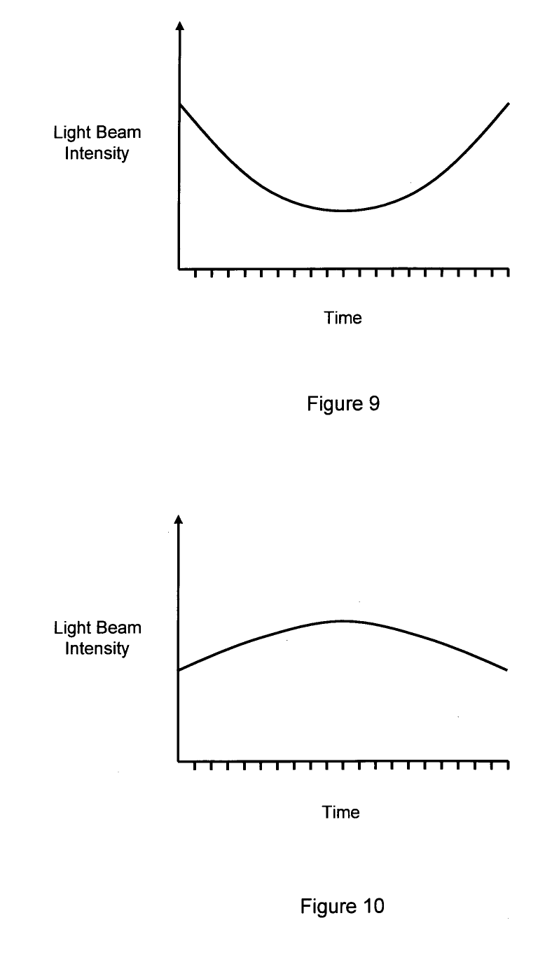

FIG. 9 shows variation in light beam intensity with time;

FIG. 10 shows alternative variation in light beam intensity with time;

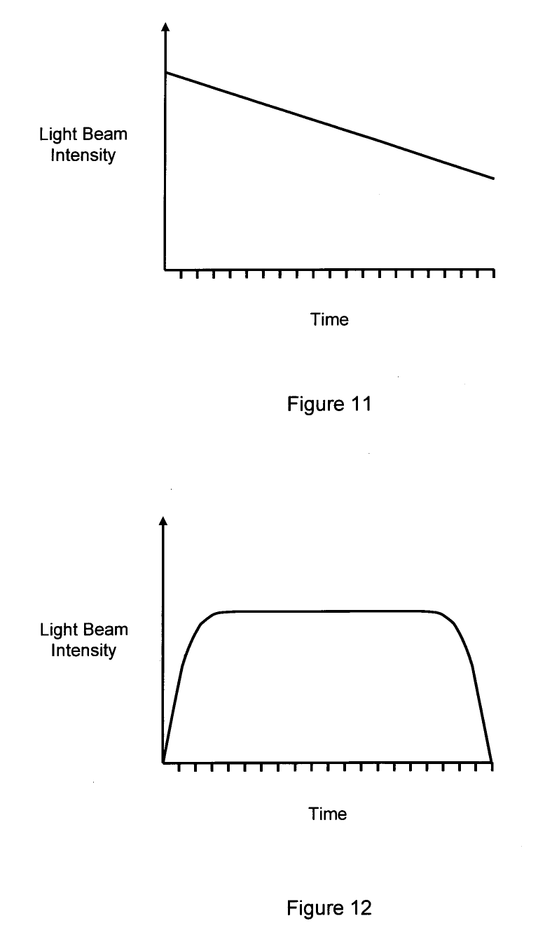

FIG. 11 shows alternative variation in light beam intensity with time;

FIG. 12 shows alternative variation in light beam intensity with time;

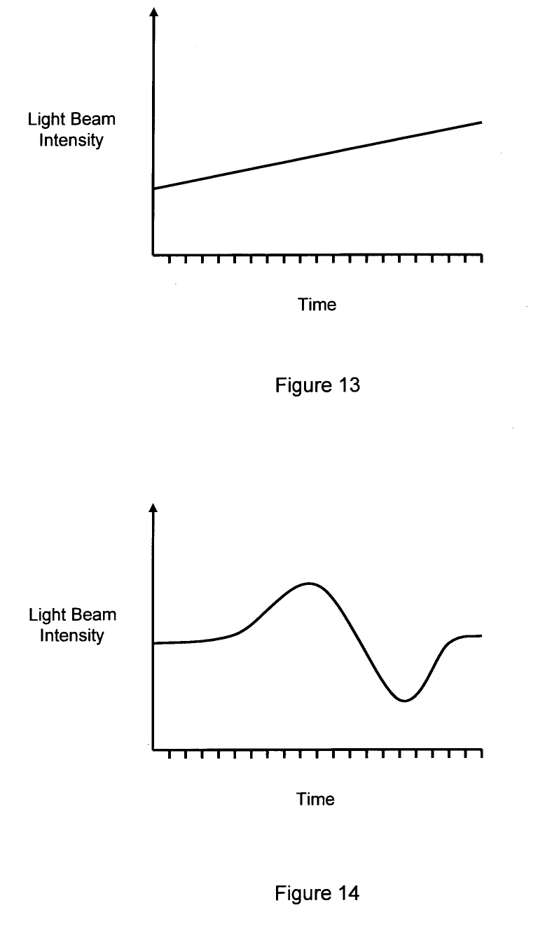

FIG. 13 shows alternative variation in light beam intensity with time;

FIG. 14 shows alternative variation in light beam intensity with time;

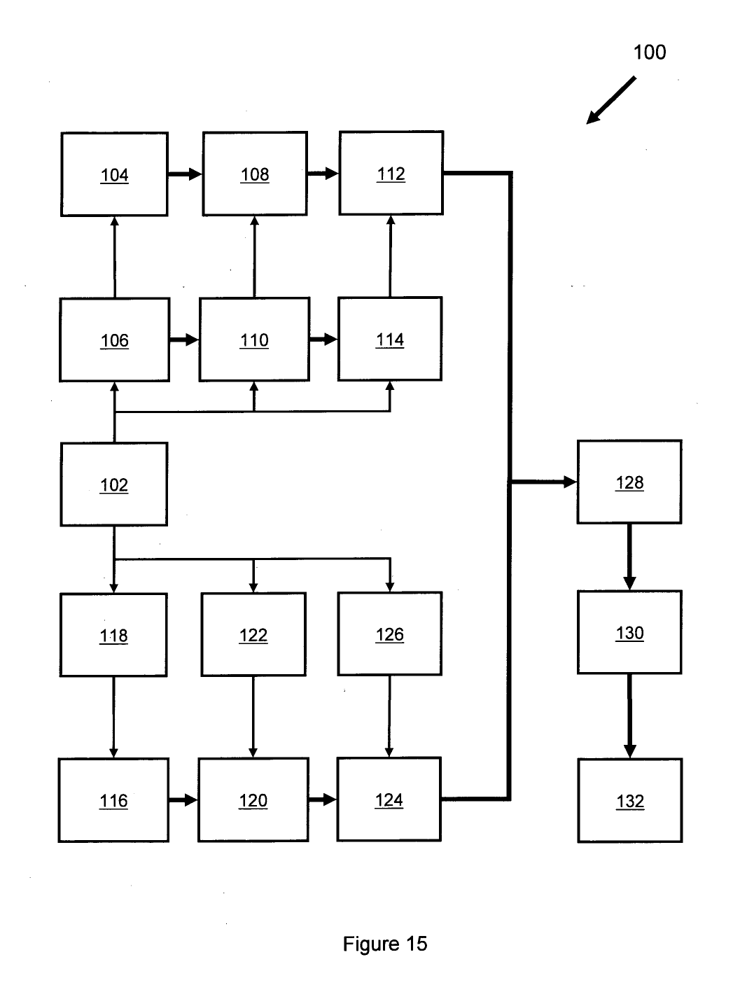

FIG. 15 shows schematically apparatus in which two light sources illuminate two separate spatial light modulators and combine images before the projection optics;

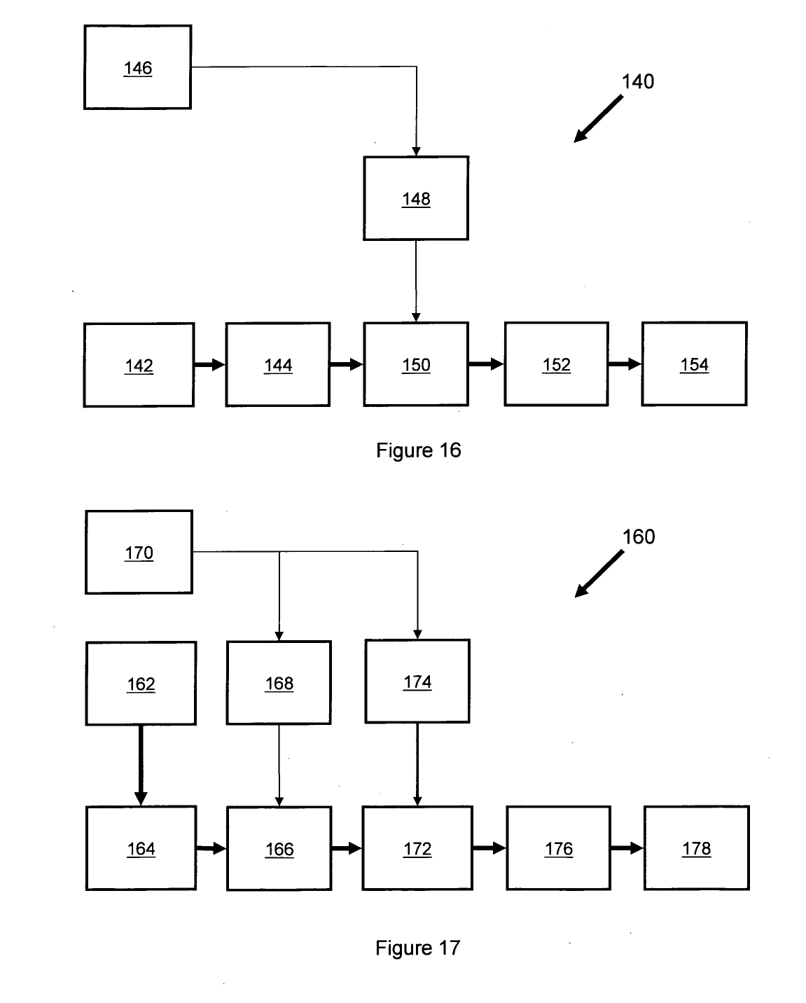

FIG. 16 first known image display apparatus using a laser light source; and

FIG. 17 shows second known image display apparatus using a laser light source.

Referring to the drawings, FIG. 1 shows schematically image display apparatus 2 of the present invention. A spatial light modulator 4 is illuminated by a light beam produced by a light source 6 and redirected by light beam redirection means 8. The modulated light is projected by projection optics 18 onto a projection screen 20. Video image data 12 is input to the light source Intensity control means 16, light beam redirection means 10 and spatial light modulator control means 14. The spatial light modulator 4 is controlled by second control means 14 for controlling the spatial light modulator 4 as a function of the video image data 12.

The light beam redirection means is controlled as a function of the video image data 12. The light beam which illuminates a portion of the spatial light modulator 4 is redirected such that the light beam will illuminate all parts of the spatial light modulator during a desired time period, illuminating each part for a portion of the desired time period to illuminate the complete spatial light modulator. All parts of the spatial light modulator may be illuminated during a single video frame or may be illuminated two or more times during a video frame.

As the light beam intensity, the light beam redirection means and the spatial light modulator are all controlled as a function of the video input data, it is possible to control these via the control means to improve the image displayed by the image display apparatus. The intensity of the light source may be altered in accordance with which portion of the spatial light modulator is illuminated and the video signal for that portion at that time. That is, if a portion of the spatial light modulator is demanding bright image information then the light beam intensity can be increased to a maximum, and if the portion of the spatial light modulator is demanding a dark image then the light beam intensity may be reduced to less than maximum intensity or for very dark portions actually reduced to minimum intensity. Essentially, as the light beam is redirected or scanned across the spatial light modulator 4, the intensity of the light beam is varied in accordance with the video image data. This will provide an increase in contrast and dynamic range of the image display apparatus. This is possible as the light source is not constant across the spatial light modulator but is varied as it is redirected by the light beam redirection means as a function of the image video data.

FIG. 2 shows image display apparatus 2 of the present invention. The image display apparatus 24 includes a light source 26 which produces a light beam 28. The redirection means comprises vertical redirection means 30 and horizontal redirection means. The light beam 28 illuminates the spatial light modulator at a portion of the spatial light modulator 36. The redirection means enables the light beam 28 to be scanned in both horizontal and vertical directions so the all the spatial light modulator 34 is illuminated for a fraction of the desired time, which may be a single frame or a multiple frame. In this embodiment of the invention, both the vertical and horizontal redirection means is a rotating or reciprocating mirror which is synchronised via the redirection control means to the image video data input to the image display apparatus.

In FIG. 2, projection optics and a projection screen for showing a projected image are not shown for clarity. The spatial light modulator may be any type of spatial light modulator. For example, the spatial light modulator may be a large direct view spatial light modulator such as a liquid crystal display panel. The image display apparatus 24 may benefit with improved performance with this type of illumination. The arrows adjacent to the spatial light modulator 34 indicate how the light beam is scanned in both a vertical and horizontal directions to enable the complete spatial light modulator to be illuminated. Also, as the light beam is directed at any portion of the spatial light modulator for a time which is a fraction of the frame time, the light beam may have an intensity which is higher than the intensity which may be used if the spatial light modulator is completely illuminated at the same time.

FIG. 3 shows apparatus 40 and in particular a spatial light modulator 42. A light beam initially illuminates a portion of the spatial light modulator 42 indicated by the dashed circle 44. The arrows 48 and 50 indicate that the light beam is redirected in both horizontal and vertical directions. The light beam commences at the top left corner of the spatial light modulator 42 and is scanned across the spatial light modulator 42 horizontally as well as being scanned vertically. Therefore, as the spot of light is moved across the spatial light modulator 42, it also moves down the spatial light modulator 42 by a fraction of the height of the spatial light modulator 42. The spot of light then returns to the left side where it is scanned across the spatial light modulator 42, again to the position indicated by a circle 46. The rate at which the light beam spot is scanned to cover all portions of the spatial light modulator 42 is determined by the redirection control means. As shown, the light beam is a circular spot.

It can also be seen that the light beam illuminates a portion of the spatial light modulator 42. Spatial light modulators consist of an array of pixels, each able to modulate the incident light. The size of the light beam may be varied such that the light beam illuminates a single pixel or a group of pixels. Scanning the light beam with the correct displacement and overlap will ensure that all pixels are illuminated by the light beam. As it is possible to calculate at which time which pixels are being illuminated by the light beam, it is possible via the light beam intensity control means, to vary the intensity in accordance with the image data being displayed by those pixels. Therefore the light beam intensity may be varied to improve the displayed image.

FIG. 4 shows a similar apparatus 52 to the apparatus shown in FIG. 3, but in this case the light beam has a cross section which is rectangular and is shown in initial position 54 by a dotted rectangle. The light beam is shown scanning horizontally and vertically by the arrows 56 and 58 to a position 62 on a spatial light modulator 60.

FIGS. 3 and 4 both show the light beam being scanned such that the spatial light modulator is only partially illuminated. If the light beam continues to scan the spatial light modulator horizontally and vertically, the light beam will illuminate all of the spatial light modulator during the desired time.

FIG. 5 shows the overall path 64 which the light beam travels to fully cover the spatial light modulator when scanned in both horizontal and vertical directions as indicated by the arrows 66 and 68.

FIG. 6 shows another embodiment of the present invention in the form of image display apparatus 70. A light source 72 produces a light beam 74 which passes through beam shaping optics 76 to shape the light beam 74. The beam shaping optics 76 may be holographic means or lenses to shape the light beam to the desired shape. In this case, the beam is spread into a rectangular shape 78 which is scanned across a spatial light modulator 80 in the horizontal direction 82 only by redirection means 84. FIG. 6 also shows that the light beam can be scanned to illuminate the complete spatial light modulator. The light beam in this case also illuminates a certain group of pixels at any one time.

FIG. 7 shows a rectangular light beam 86 illuminating the top portion of a spatial light modulator 88 at the start of a scanning period. The direction of scanning is indicated by arrow 90. FIG. 7 shows that the light beam may be scanned either horizontally or vertically across a panel using the rectangular light beam 86.

FIG. 8 shows a light beam 92 at the end of a scanning period, having scanned a spatial light modulator 94 in a direction 96 from an initial starting position 98. FIG. 8 shows that the complete spatial light modulator is illuminated during the desired period.

FIGS. 9, 10, 11, 12, 13 and 14 show how the light beam intensity may be varied as it is scanned across or down a spatial light modulator. The variation can be smooth to vary gradually across the spatial light modulator. Alternatively, the variation can consist of more abrupt changes in intensity. The intensity is controlled by the light intensity control means. When the light beam is scanned both horizontally and vertically, the variation in intensity may be different for each horizontal scan. When the spatial light modulator is scanned in a single direction only, the variation will be for the single scan in that direction. The intensity could also be changed as a fixed intensity profile on a line image.

FIG. 15 shows schematically image display apparatus 100 in which a first image display apparatus can be combined with a second image display apparatus. Video image data 102 is common to both. The first image display apparatus has a light source 104, light source control means 106, light beam redirection means 108, control means for controlling the light beam redirection 110, spatial light modulator 112 and spatial light modulator control means 114. The second image display apparatus has a light source 116, light source control means 118, light beam redirection means 120, control means for controlling the light beam redirection 122, spatial light modulator 124 and spatial light modulator control means 126.

Modulated light from each image display apparatus is combined optically by optical means 128 such that the combined image is able to be displayed via projection optics 130 on a projection screen 132. If the light source 104 of the first image display apparatus is of a first wavelength, and the light source 116 of the second image display apparatus is of a second and different wavelength, then known optical means such as dichroic combiners may be used to combine the modulated light from each apparatus. This principle of operation may be extended to include third image display apparatus having a light source of a third and different wavelength, and to a fourth image display apparatus having a light source of a fourth and different wavelength.

FIG. 15 also shows schematically how a combination of different wavelength or coloured images may be made prior to projection. The images may alternatively be combined when projected on to a screen, which may be a front or a rear projection screen.

An alternative method to provide a full colour image is to optically combine two or more light beams, and to image this combined light beam onto the spatial light modulator. Each light source is still intensity controlled and redirected by redirection means to illuminate the complete spatial light modulator. The light beams may be redirected by the same redirection means.

The embodiments of the invention described above with reference to the drawings show how image display apparatus of the invention can have an improved performance, and especially an improved projected display. This is achieved by adjusting the intensity of the light source and consequently the light beam illuminating the spatial light modulator, the intensity being varied as a function of the video data input. This enables those portions of the image which are dark to be illuminated with low intensity and those portions which are bright to be illuminated with high intensity illumination. This improves performance in the contrast and dynamic range of the display.

The light source for the image display apparatus may be a laser light source producing a laser light beam or a light emitting diode light source. Although the light source is shown in the drawings as a single light beam which is redirected by, mechanical means such for example as mirrors, the image display apparatus may also provide improvements in other configurations. The light source for example may be a cathode ray tube scanned laser light source. In this case, the light source redirection is accomplished by the scanning cathode ray tube. The light is redirected to different portions of the spatial light modulator with the intensity being varied at each of these portions. One such method of achieving this is to use an eVCSEL laser light source.

FIG. 16 shows first known image display apparatus 140 using a laser light source. The apparatus 140 has a light source 142 which produces a light beam which is shaped by light shaping means 144 to such a shape that the full spatial light modulator 150 is illuminated simultaneously. The video image data 146 is input to spatial light modulator control means 148 which controls a spatial light modulator 150. The modulated light is projected via projection optics 152 to a screen 154. In this known image display apparatus 140, the light beam is not scanned to fully illuminate the spatial light modulator 130 but is expanded such that the spatial light modulator 130 is fully illuminated.

FIG. 17 shows second known display apparatus 160 having a laser light source. The image display apparatus 160 has a light source 162 which produces a light beam which is shaped by beam shaping optics 164. The beam shaping optics 164 shape the light beam into a line. The line-shaped light beam is directed to a spatial light modulator 166 which is a line spatial light modulator. The line spatial light modulator is controlled by control means 168 which receives image information from video image data 170. The light modulated by the line spatial light modulator 166 is then redirected by redirection means 172. This redirection is controlled by control means 174 in accordance with video information received from the video image data. The modulated image is therefore scanned by the redirection means 172 in one direction such that a two dimensional image may be formed. The redirected image is displayed on a projection screen 178 via projection optics 176.

In both the image display apparatus 140 and the image display apparatus 160, the light source intensity is not varied and, in particular, is not varied in accordance with any video information, and fills the spatial light modulator fully at all times.

It is to be appreciated that the embodiments of the invention described above with reference to the accompanying drawings have been given by way of example only and that modifications may be effected.

1. Image display apparatus comprising a spatial light modulator, at least one light source for producing a light beam which illuminates a portion of the spatial light modulator, light beam redirecting means to redirect the light beam such that all portions of the spatial light modulator are able to be illuminated, first control means for controlling the redirection of the light beam as a function of video data input to the image display apparatus, second control means for controlling the spatial light modulator as a function of the video data input to the image display apparatus, and third control means for controlling the illumination intensity of the light beam as a function of the video data input to the image display apparatus.

2. Image display apparatus according to claim 1 in which the spatial light modulator comprises a reflective spatial light modulator or a transmissive spatial light modulator.

3. Image display apparatus according to claim 2 in which the reflective spatial light modulator is a liquid crystal reflective spatial light modulator or a micro electro-mechanical system.

4. Image display apparatus according to claim 3 in which the transmissive spatial light modulator is a transmissive liquid crystal spatial light modulator.

5. Image display apparatus according to claim 1 in which the light source is a laser light source.

6. (canceled)

7. (canceled)

8. (canceled)

9. Image display apparatus according to claim 1 in which the light source is a light emitting diode light source comprising one or more light emitting diodes.

10. (canceled)

11. (canceled)

12. (canceled)

13. Image display apparatus according to claim 1 in which the light beam which illuminates a portion of the spatial light modulator is circular, rectangular, or elliptical in cross section.

14. Image display apparatus according to claim 1 in which the light beam redirecting mean is optical light beam redirecting means.

15. (canceled)

16. Image display apparatus according to claim 1 which the light beam redirecting means is a spatial light beam redirecting means.

17. Image display apparatus according to claim 1 in which the video data input is monochrome image data.

18. (canceled)

19. (canceled)

20. (canceled)

21. Image display apparatus according to claim 1 in which the first control means for controlling the redirection of the light beam extracts necessary data from the video data input.

22. (canceled)

23. Image display apparatus according to claim 1 in which the second control means for controlling the spatial light modulator extracts necessary data for controlling the spatial light modulator as a function of the video data input.

24. Image display apparatus according to claim 1 in which the third control means for controlling the illumination intensity extracts data from the video data input to control the intensity of the light source.

25. Image display apparatus according to claim 24 in which the light source intensity is controlled as a function of the video data input by being a function of the video information or a function of the video timings, or in conjunction with the light beam redirection and controlled as a function of the position of the light beam relative to the spatial light modulator.

26. Image display apparatus according to claim 1 in which images are projected by projection optics onto a projection screen.

27. (canceled)

28. Image display apparatus according to claim 1 in which the spatial light modulator is incorporated into a projection screen.

29. (canceled)

30. Image display apparatus according to claim 1 and in conjunction with other like apparatus, each displaying a different monochrome image to provide full colour image display apparatus.

31. (canceled)

32. (canceled)

33. Image display apparatus according to claim 1 in which the first, second and third control means forms separate parts of a single control means.

34. (canceled)

35. Image display apparatus according to claim 1 in which there is more than one of the light sources, and in which each of the light sources has its own one of the redirection means and the intensity control means.

36. Image display apparatus according to claim 1 in which the one or more light sources are configured using optical means to illuminate a single spatial light modulator which modulates the intensity of combined light beams such that a color image is able to be displayed using a projection optics.
